(19) United States
(12) Patent Application Publication
(10) Pub. No.: US 2004/0012102 A1
(43) Pub. Date: Jan. 22, 2004

(54) Carburetor

(75) Inventor: Reinhard Gerhardy, Korb (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 10/622,060

(22) Filed: Jul. 17, 2003

(30) Foreign Application Priority Data
Jul. 17, 2002 (DE) 102 32 341.0

(51) Int. Cl. F02M 1/00

(52) U.S. Cl. 261/38

(57) ABSTRACT

A carburetor, especially for the internal combustion engine in a motor-driven implement, is provided. Formed in the carburetor is an intake channel that has at least one partition extending in the direction of the longitudinal axis of the intake channel. The partition divides the intake channel into at least one air channel and at least one mixture channel. At least one fuel nozzle opens into the mixture channel. Pivotably mounted in the intake channel is a butterfly valve. To obtain a favorable starting and acceleration condition, with reduced exhaust gas values in the full throttle range, the butterfly valve is provided with at least two sections that are moveable relative to one another.

### BACKGROUND OF THE INVENTION

The present invention relates to a carburetor, especially for the internal combustion engine in a motor-driven implement.

U.S. Pat. No. 6,101,991 discloses a two-cycle engine having a partition formed in the intake channel thereof. The partition divides the intake channel into an air channel that conveys substantially fuel-free air, as well as into a mixture channel that conveys fuel/air mixture. In the carburetor, a butterfly valve is disposed in the partition. Due to the common butterfly valve, the air channel and the mixture channel are opened or closed together. When the two-cycle engine is started, a sufficient supply of fuel is necessary. In contrast, the amount of fuel-free air that is supplied should be relatively low. In order with a two-cycle engine according to U.S. Pat. No. 6,101,991 to achieve an adequate supply of fuel during the starting process or in the lower partial load range and during acceleration, the carburetor must be appropriately adjusted. This means that even in the full throttle range a correspondingly large amount of fuel is supplied. Consequently, the exhaust gas values of such an engine are impaired.

It is therefore an object of the present invention to provide a carburetor, especially for the internal combustion engine in a motor-driven implement, that enables a control of the fuel and air supply that is adapted to the operating range or condition of the engine.

### BRIEF DESCRIPTION OF THE DRAWINGS

This object, and other objects and advantages of the present invention, will appear more clearly from the following specification in conjunction with the accompanying schematic drawings, in which:

FIG. 1 shows a two-cycle engine having one exemplary embodiment of an inventive single-flow carburetor;

FIG. 2. is a side view of a carburetor taken in the direction of the arrow II in FIG. 1;

FIG. 3 shows the carburetor of FIG. 2 with the butterfly valve in the open position;

FIG. 4. is a view of the carburetor taken in the direction of the arrow IV in FIG. 2;

FIG. 5 is a cross-sectional view through the carburetor taken along the line V-V in FIG. 2.

### SUMMARY OF THE INVENTION

The carburetor of the present invention includes an intake channel formed in the carburetor, wherein at least one partition is disposed in the intake channel, extends in the direction of the longitudinal axis thereof, and divides the intake channel into at least one air channel and at least one mixture channel, wherein at least one fuel nozzle opens out into the mixture channel, wherein a butterfly valve is pivotably mounted in the intake channel, and wherein the butterfly valve is provided with at least two sections that are moveable relative to one another.

Forming the butterfly valve with at least two sections that are moveable relative to one another makes it possible to already open a channel formed in the intake channel, while another channel remains closed. Especially during start-up, in the lower partial throttle range, and during acceleration, it is thereby possible to control the supply of air in such a way that the supply of fuel/air mixture is increased and the mixture thus become richer.

In particular, it is provided that one section of the butterfly valve form an air valve section that in the closing position substantially closes at least one air channel, and that the other section of the butterfly valve form a mixture valve section that in the closing position, in other words in the idling position, substantially closes at least one mixture channel. Thus, for idling the mixture channel can already be slightly opened, while the air valve section still substantially closes off the air channel. This prevents the underpressure in the mixture channel, which brings about the fuel supply, from being reduced by in-flowing air and thereby reducing the supply of fuel. The carburetor can be set lean, so that good exhaust gas values result in the full throttle range. A good starting condition results if the sections, starting from the closing position of the butterfly valve, are moveable relative to one another by about 5 to 25°, especially by 10 to 20°.

A favorable structural embodiment results if one section is fixedly connected with a shaft, and another section is fixedly connected with a hollow shaft, whereby at least a portion of the length of the first shaft is surrounded by the hollow shaft. This results in a space-saving arrangement. As a consequence, it is also possible to centrally mount both of the valve sections. One section is advantageously connected with a cross member that is disposed on the hollow shaft. The hollow shaft thus does not extend over the entire width of the intake channel. Furthermore, the hollow shaft thereby does not obstruct the relative movement of the valve sections. At the same time, sufficient installation space is provided for fixing the section on the shaft, for example via a screw.

The air valve section is advantageously spring-loaded in the direction toward its closing position. This spring ensures that the air valve section substantially closes off the air channel while the mixture valve section is already opening. Due to the spring-loading, the relative position of the sections to one another can be maintained up to complete opening of the butterfly valve. Thus, in the opening position the air valve section is not completely open, but rather is opened by an angle that corresponds to the rotational moveability of these sections relative to one another and remains inclined relative to the longitudinal axis of the intake channel. A first end of the spring is expediently fixed in position on the carburetor housing, and a second end of the spring is fixed in position on an air valve shaft that is fixedly connected with the air valve section. To fix the rotational moveability, it is provided that an engagement member is connected with an air valve shaft, with a further engagement member, which is connected with a butterfly valve shaft, being associated with the first engagement member, whereby the air valve shaft is fixedly connected with the air valve section, and the butterfly valve shaft is fixedly connected with the mixture valve section. In the closing position of the air valve section and the mixture valve section of the butterfly valve, the two engagement members have an angular spacing from one another in the circumferential direction that corresponds to the maximum rotational moveability of the butterfly valve sections relative to one another. When the mixture valve section opens, the angular spacing of the engagement members is reduced in conformity with the opening angle of the mixture valve section. When the maximum rotational moveability is reached, the engagement members rest against one another so that upon a further opening movement of the mixture valve section, the air valve section is correspondingly also opened.

The air valve shaft and the butterfly valve shaft advantageously extend at least from the intake channel to the outer side of the carburetor housing. The engagement members can thus be disposed on the outer side of the housing. However, it is also possible to provide the engagement members on the butterfly valve shaft and the air valve shaft in the interior of the intake channel or in the interior of the housing. A disk is expediently fixedly connected with the butterfly valve shaft on the outer side of the housing, whereby the engagement member is disposed on the disk. In particular, the air valve shaft extends from the disk that is connected with the butterfly valve shaft into the intake channel. An easy to manufacture embodiment of the engagement members results if a disk is fixedly disposed on the air valve shaft, and the engagement member is disposed on this disk. The engagement members are, in this connection, advantageously embodied as dogs or pawls that, on the disks that are disposed next to one another, come into engagement with one another.

Further specific features of the present invention will be described in detail subsequently.

### DESCRIPTION OF PREFERRED EMBODIMENTS

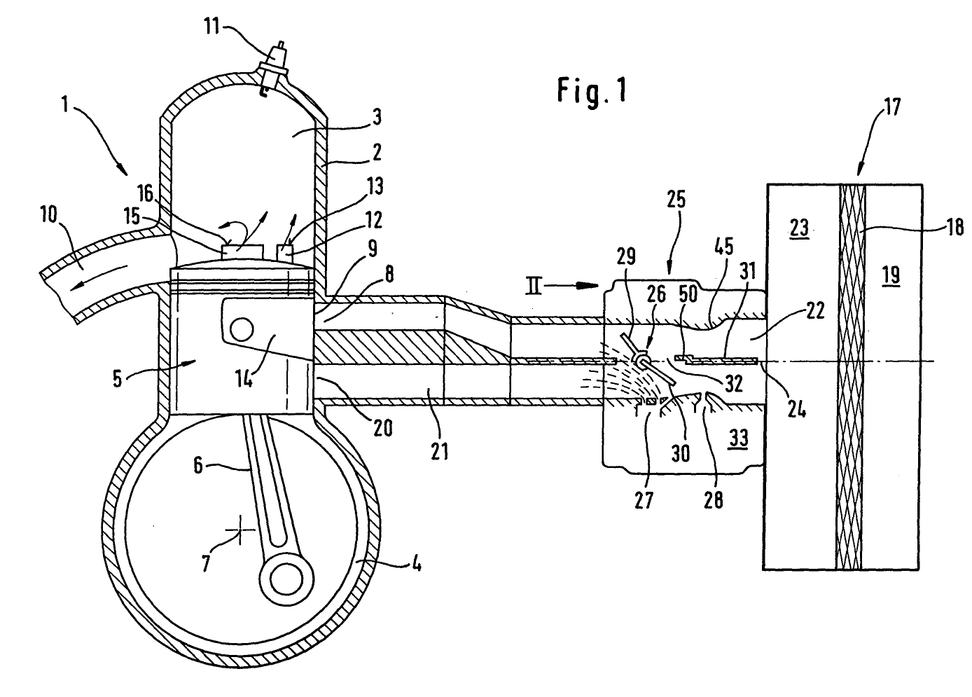

Referring now to the drawings in detail, the two-cycle engine 1 schematically illustrated in FIG. 1 is, in particular, disposed in a manually-guided implement, such as a power chain saw, a cut-off machine, or the like. The two-cycle engine 1 has a cylinder 2 in which is formed a combustion chamber 3. The combustion chamber 3 is delimited by a reciprocating piston 5 that, via a connecting rod 6, drives a crankshaft 7 that is rotatably mounted in a crankcase 4. The two-cycle engine 1 has an inlet 20 for fuel/air mixture into the crankcase 4, as well as an outlet 10 for the withdrawal of exhaust gases from the combustion chamber 3. In prescribed positions of the piston 5, the crankcase 4 is connected with the combustion chamber 3 via two symmetrically arranged transfer channels 12 that are remote from the outlet 10, as well as two symmetrically arranged transfer channels 15 that are near the outlet 10. The transfer channels 12 and 15 open into the combustion chamber 3 via transfer windows 13 and 16 respectively. Other arrangements of the transfer channels, as well as a different number of transfer channels, can also be expedient. Disposed in the piston 5 are two symmetrically formed piston windows 14 that in prescribed positions of the piston, especially in the region of the upper dead center position, fluidically connect an air channel 8, which conveys substantially fuel-free air and opens into the cylinder 2 via an air channel window 9, with the transfer windows 13 and 16 of the transfer channels 12 and 15.

During operation of the two-cycle engine 1, in the region of the upper dead center position of the piston 5, fuel/air mixture is supplied to the crankcase 4 from the mixture channel 21 via the inlet 20. At the same time, substantially fuel-free air is supplied to the transfer channels 12 and 15 via the piston window 14. The supply of fuel/air mixture and substantially fuel-free air can also be effected in a time-delayed manner. The fuel/air mixture is compressed in the crankcase 4 during the downward stroke of the piston 5. In the region of the upper dead center position of the piston 5, the transfer windows 13 and 16 open to the combustion chamber 3. First, substantially fuel-free air flows out of the transfer channels 12 and 15, and subsequently fuel/air mixture flows out of the crankcase 4 into the combustion chamber 3. The substantially fuel-free air displaces the exhaust gases that are still in the combustion chamber 3 through the outlet 10. During the upward stroke of the piston 5, the fuel/air mixture in the combustion chamber 3 is compressed, and is ignited in the region of the upper dead center position of the piston 5 by the spark plug 11. Due to the combustion, the piston 5 is forced in the direction toward the lower dead center position. The exhaust gases in the combustion chamber 3 flow through the outlet 10 as soon as this outlet is released by the piston 5. The exhaust gases that still remain in the combustion chamber 3 are displaced toward the outlet 10 by the substantially fuel-free air that flows in through the transfer channels, as well as by the subsequently flowing-in fuel/air mixture.

For the preparation of the fuel/air mixture, a carburetor 25 is provided that in particular is embodied as a diaphragm carburetor. Formed in the carburetor 25 is an intake channel 22. In the carburetor 25, a rotatably mounted butterfly valve 26 is disposed in the region of the idling nozzles 27. A venturi section 45 is formed in the intake channel 22 upstream of the butterfly valve 26. In the region of the venturi section 45, a main nozzle 28 is provided for the supply of fuel into the intake channel 22. A partition 31 is disposed in the intake channel 22 and extends in the direction of the longitudinal axis 24 of the intake channel. This partition 31 expediently extends over the entire length of the carburetor 25. The partition 31 divides the intake channel 22 into the air channel 8 and the mixture channel 21. The air channel 8 and the mixture channel 21 are also separately embodied downstream of the carburetor 25 up to the two-cycle engine. The idling nozzles 27, as well as the main nozzle 28, open out into the mixture channel 21, whereas substantially fuel-free air is supplied to the air channel 8.

In the region of the butterfly valve 26, the partition 31 has a connection opening 32, the cross-sectional area of which in particular corresponds approximately to the cross-section area of the butterfly valve 26. The butterfly valve 26 has two sections that are moveable relative to one another, namely an air valve section 29 and a mixture valve section 30. In the closing position, the mixture valve section 30 closes off the mixture channel 21 in a substantially airtight manner, while the air valve section 29 is disposed in the region of the air channel 8 and in the closing position substantially closes off the air channel in an airtight manner. When the butterfly valve 26 is not completely opened, the air channel 8 is connected with the mixture channel 21 via the connection opening 32. Thus, a portion of the fuel can flow through the connection opening 32 into the air channel 8. In the full throttle range, the mixture valve section 30 rests against an abutment surface 50 formed on the partition 31. In the full throttle range, the abutment surface 50 expediently adjoins the mixture valve section 30 in a sealing manner.

Due to the relative moveability of the butterfly valve sections relative to one another, in the full throttle range the air valve section 29 can be inclined relative to the longitudinal axis 24 of the intake channel 22. In this range, the partition 31 can be embodied in such a way that also in the region of the air valve section 29, the air channel 8 and the mixture channel 21 are fluidically separated from one another. In so doing, a storage of air is achieved in the transfer channels 12 and 15 with substantially fuel-free air, so that the fuel portion that escapes through the outlet 10 is low. However, a gap can also remain between the partition 31 and the air valve section 29.

Disposed upstream of the carburetor 25 is an air filter 17, which has a dirty chamber 19 and a clean chamber 23 that is separated from the clean 19 chamber by filter material 18. The intake channel 22 opens out at the clean chamber 23 of the air filter 17. This prevents dirt particles from being conveyed to the internal combustion engine 1. The partition 31 can advantageously extend into the air filter 17 up to the filter material 18.

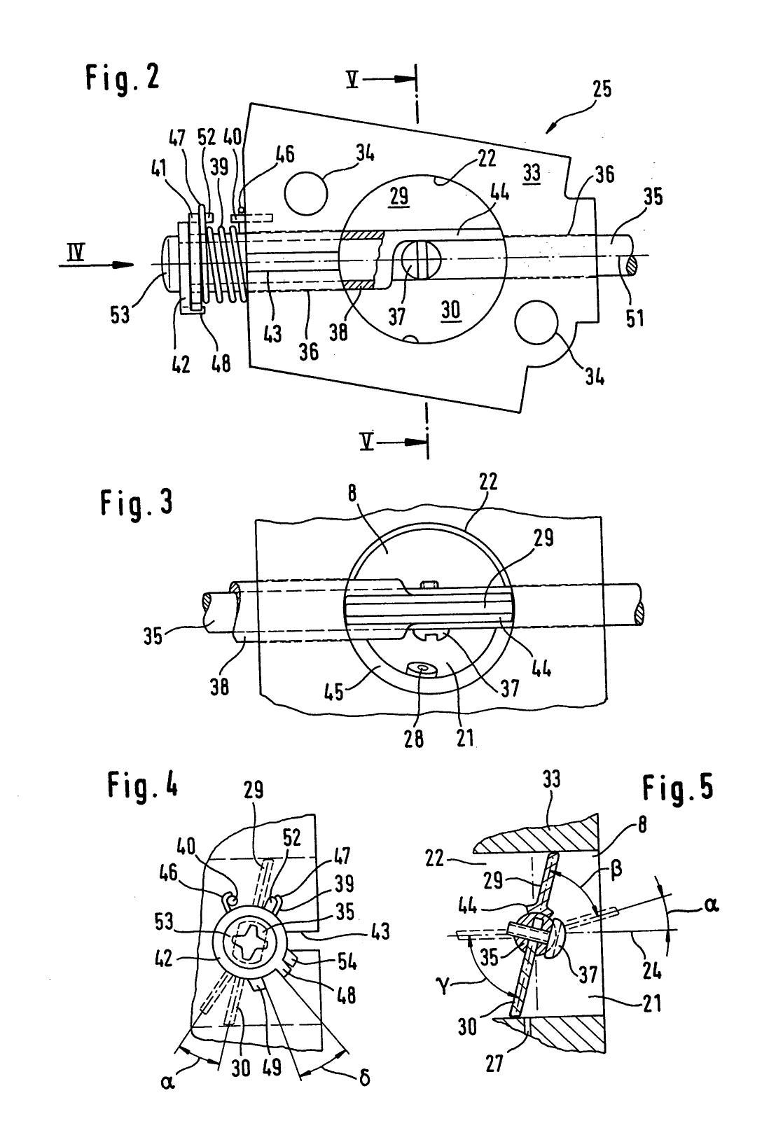

In FIG. 2, the carburetor 25 is illustrated in a side view. The carburetor 25 is provided with a carburetor housing 33, in which the intake channel 22 is formed. The carburetor housing 33 has two mounting openings 34 via which the carburetor 25 can, for example, be fixed in position on the air filter 17. In FIG. 2, the butterfly valve 26, which includes the air valve section 29 and the mixture valve section 30, is illustrated in the closed position, i.e. in the idling position. In this connection, the idling is established only by an adjustment, in other words by a slight opening, of the mixture valve section 30. The air valve section 29 thus substantially closes the air channel 8, while the mixture valve section 30 substantially closes the mixture channel 21, in other words in conformity with the idling position. The mixture valve section 30 is fixed via a screw 37 on a throttle or butterfly valve shaft 35 that extends through the carburetor housing 33. The air valve section 29 is fixed on a cross member 44 that extends in the intake channel 22 in the direction of the longitudinal axis 51 of the butterfly valve shaft 35. The cross member 44 is fixedly connected with a hollow shaft 38. In particular, the cross member 44 is monolithically formed with the hollow shaft 38 as a portion thereof. The hollow shaft 38 extends from the intake channel 22 up to the outer side of the carburetor housing 33. The hollow shaft 38 is disposed concentrically relative to the butterfly valve 35 and surrounds the same. The butterfly valve shaft 35 is thus mounted on one side of the intake channel 22 in the hollow shaft 38, and on the opposite side in a bearing means 36 formed in the housing 33. In this connection, the bearing means 36 is in particular embodied as a bore in the housing 33. The hollow shaft 38 is similarly mounted in a bearing means 36 that is embodied as a bore in the housing 33.

The air valve section 29 is spring-loaded in a closing direction. For this purpose, a helical spring 39 is provided, a first end 46 of which is fixed in position on a pin 40 that extends into the carburetor housing 33. The helical spring 39 is disposed coaxially relative to the longitudinal axis 51 of the butterfly valve shaft 35. The second end 47 of the helical spring 39 is fixedly connected with the hollow shaft 38. For this purpose, a disk 41 is disposed on that end of the hollow shaft 38 that extends out of the housing 33; the second end 47 of the helical spring 39 is fixed in position on a finger 52 of the disk 41. Disposed on that side of the disk 41 that faces away from the housing 33 is a further disk 42 that is fixedly connected with the butterfly valve shaft 35. The disks 41, 42 can, for example, be axially fixed by a screw 53.

In FIG. 3, the butterfly valve 26 is illustrated in the open position. In this connection, the air valve section 29 is shown in the plane of the partition 31. However, the air valve section 29 could also be inclined relative to this plane. The air valve section 29 is fixed in position on the cross member 44 that is connected with the hollow shaft 38. Formed in the intake channel 22 is the venturi section 45, in the region of which the main nozzle 28 opens into the mixture channel 21. In the air channel 8, the venturi section 45 has a less pronounced configuration.

The air valve section 29 and the mixture valve section 30 are coupled with one another via engagement members 48, 49. As illustrated in FIG. 4, one engagement member 48 is disposed on the disk 42 that is fixedly connected with the butterfly valve shaft 35. The other engagement member 49 is disposed on the disk 41 that is fixedly connected with the hollow shaft 38. In the closing position of the butterfly valve 26, the engagement members 48, 49 have an angular spacing δ relative to one another. This angular spacing is from 5 to 25°, especially from 10 to 20°. An angular spacing δ of about 15° is seen as being advantageous. In the closing position of the butterfly valve 26, the engagement member 48 rests against an abutment 54 that is advantageously formed on the disk 41. If the mixture valve section 30 opens, the engagement member 48 moves in a direction toward the engagement member 49. As soon as the mixture valve section 30 has moved by the maximum rotational moveability α, the engagement member 48 rests against the engagement member 49. Upon further opening of the mixture valve section 30, the air valve section 29 is taken along by the engagement members 48, 49, so that the air valve section 29 also opens. With a significant underpressure in the air channel 8, the air valve section 29 can open against the force of the spring 39 until the engagement member 48 comes to rest against the abutment 54. Thus, too great of an enrichment of the fuel/air mixture due to the underpressure can be prevented.

FIG. 5 makes clear the angular positions of the air valve section 29 and of the mixture valve section 30. The mixture valve section 30 can move about an opening angle γ up to the completely open position. The opening angle γ is advantageously approximately 75°. Until the mixture valve section 30 has opened about the rotational movement α, the air valve section 29 remains closed. Only thereafter is the air valve section 29 opened. The air valve section 29 thus has an opening angle β that corresponds to the difference of the opening angle γ of the mixture valve section 30 and the maximum rotational movement α. In the opening position, the air valve section 29 is thus inclined by the maximum rotational movement α relative to the longitudinal axis 24 of the intake channel 22. In this inclined position, however, the air valve section 29 is disposed in the shadow of the butterfly valve shaft 35, thus avoiding an influencing of the flow in the intake channel 22. The air valve section 29 can, however, also be disposed in the plane of the partition 31.

For assembly, a slot 43 is provided in the carburetor housing 33 through which can be inserted first the mixture valve section 30 with the fixed butterfly valve shaft 35 and subsequently the air valve section 29 with the hollow shaft 38 fixed thereon. An assembly through the intake channel 22 is not readily possible due to the partition 31.

FIG. 4 clearly shows the arrangement of the helical spring 39 having the second end 47 on the finger 52 as well as the first end 46 on the pin 40. FIG. 5 illustrates the arrangement of the cross member 44 on the periphery of the butterfly valve shaft 35,

It can be expedient to provide further partitions for dividing the intake channel 22 into a number of sections. It can also be expedient to divide the butterfly valve 26 into a plurality of sections. It can furthermore be advantageous to fixedly connect the mixture valve section with a hollow shaft, and to fixedly connect the air valve section with a solid shaft.

The specification incorporates by reference the disclosure of priority document DE 102 32 341 of Jul. 17, 2002.

The present invention is, of course, in no way restricted to the specific disclosure of the specification and drawings, but also encompasses any modifications within the scope of the appended claims.

What is claimed is:

1. A carburetor, including an intake channel formed in said carburetor, wherein at least one partition is disposed in said intake channel, extends in the direction of a longitudinal axis of said intake channel, and divides said intake channel into at least one air channel and at least one mixture channel, where at least one fuel nozzle opens out into said at least one mixture channel, wherein a butterfly valve is pivotably mounted in said intake channel, and wherein said butterfly valve is provided with at least two sections that are moveable relative to one another.

2. A carburetor according to claim 1, wherein one of said sections of said butterfly valve forms an air valve section that in a closing position substantially closes off at least one air channel.

3. A carburetor according to claim 2, wherein another section of said butterfly valve forms a mixture valve section that in a closing position substantially closes off a mixture channel.

4. A carburetor according to claim 1, wherein said sections of said butterfly valve, starting from a closing position of said butterfly valve, are moveable relative to one another by approximately 5 to 25°.

5. A carburetor according to claim 4, wherein said sections of said butterfly valve are moveable relative to one another by about 10 to 20°.

6. A carburetor according to claim 1, wherein one of said sections of said butterfly valve is fixedly connected with a first shaft, wherein another section of said butterfly valve is fixedly connected with a hollow shaft, and wherein at least a portion of a length of said first shaft is surrounded by said hollow shaft.

7. A carburetor according to claim 6, wherein said another section of said butterfly valve is connected with a cross member that is disposed on said hollow shaft.

8. A carburetor according to claim 2, wherein said air valve section of said butterfly valve is spring-loaded in the direction toward a closing position thereof.

9. A carburetor according to claim 8, wherein a first end 46 of a spring is fixed in position on a housing of said carburetor, and wherein a second end of said spring is fixed in position on an air valve shaft that is fixedly connected with said air valve section.

10. A carburetor according to claim 3, wherein a first engagement member is connected with an air valve shaft, wherein a second engagement member is connected with a butterfly valve shaft, wherein said second engagement member is associated with said first engagement member, wherein said air valve shaft is fixedly connected with said air valve section, wherein said butterfly valve shaft is fixedly connected with said mixture valve section, and wherein said first and second engagement members in a closing position of said air valve section and said mixture valve section of said butterfly valve, have an angular spacing from one another in a circumferential direction that corresponds to a maximum rotational moveability of said air valve section and said mixture valve section relative to one another.

11. A carburetor according to claim 10, wherein said air valve shaft and said butterfly valve shaft extend at least from said intake channel to an outer side of a housing of said carburetor.

12. A carburetor according to claim 11, wherein a first disk is fixedly connected with said butterfly valve shaft on an outer side of said carburetor housing, and wherein said second engagement member is disposed on said first disk.

13. A carburetor according to claim 12, wherein said air valve shaft extends from said first disk up to into said intake channel.

14. A carburetor according to claim 10, wherein a second disk is fixedly disposed on said air valve shaft, and wherein said first engagement member is disposed on said second disk.
